(19) United States
(12) Patent Application Publication
(10) Pub. No.: US 2008/0217174 A1
(43) Pub. Date: Sep. 11, 2008

(54) Gas Sensor

(76) Inventor: Johannes Kanters, Ludwigsburg (DE)

Correspondence Address: KENYON & KENYON LLP, ONE BROADWAY, NEW YORK, NY, 10004, US

(21) Appl. No.: 11/884,339

(22) PCT Filed: Feb. 7, 2006
(86) PCT No.: PCT/EP06/50710

§ 371 Date: Apr. 4, 2008

(30) Foreign Application Priority Data
Feb. 14, 2005 (DE) 10 2005 006 501.5

(51) Int. Cl. G01N 27/26

(52) U.S. Cl. 204/427; 204/424

(57) ABSTRACT

A gas sensor is provided for determining the concentration of a gas component in a measuring gas, in particular for determining the oxygen concentration in the exhaust gas of internal combustion engines, which has an electrode pair situated on a solid-state electrolyte and made up of an outer pump electrode and an inner pump electrode, which is accessible to the measuring gas supplied via a diffusion barrier, the electrode pairs being triggered in a clocked manner and having a potential of varying polarity applied in each clock-pulse period. To improve the measuring precision of the gas sensor without additional electrodes, a cavity is situated between the diffusion barrier and the inner pump electrode, the cavity serving as storage volume for the oxygen pumped through the solid-state electrolyte.

### FIELD OF THE INVENTION

The present invention is based on a gas sensor for determining the concentration of a gas component in a measuring gas, in particular for determining the oxygen concentration in the exhaust gas of internal combustion engines.

### BACKGROUND INFORMATION

In a gas-measuring probe or gas sensor for determining the λ-value in exhaust gases of internal combustion engines (M. Oshuga & Y. Ohyama “A study on the oxygen-biased wide range air-fuel ratio sensor for rich and lean air-fuel ratios”, Sensors and Actuators, 9 (1986), pages 287-300), the outer pump electrode of the electrode pair situated on the solid-state electrolyte is exposed to the atmosphere, and the inner pump electrode is covered by a diffusion barrier, which has an adapted thickness and is acted upon by the exhaust gas. The electrode pair is controlled in a clocked manner, and the inner pump electrode and the outer pump electrode are alternately connected to a potential of varying magnitude, which causes oxygen from the atmosphere to be pumped into the diffusion barrier (pump-in phase) and from the diffusion barrier to the atmosphere (evacuation phase) in alternation. In so doing, a current—referred to as bias current—is flowing from the inner pump electrode to the outer pump electrode in the pump-in phase, and a pump current—referred to as sensing current or measuring current—is flowing from the outer pump electrode to the inner pump electrode in the evacuation phase. The last current value in each evacuation phase is detected with the aid of a sample and hold circuit and supplies the measure for the oxygen concentration as λ-value of the exhaust gas. The last current value in each evacuation phase is likewise detected with the aid of a sample and hold circuit and supplies a control signal for an electrical heater with the aid of which the temperature of the solid-state electrolyte is controlled to a constant value.

For the clocked control of the electrode pair, the electrode pair is situated in the bridge branch of a switch bridge made up of four electronic switches, of which two switches that are lying in two diagonal branches are triggered by the clock pulses of a clock-pulse generator, and two switches that are lying in the two other diagonal branches are triggered by the inverted clock pulses, which are shifted by half a clock-pulse period. Due to the alternate biasing into conduction of the individual switch pairs, two potentials that vary in polarity are applied to the electrode pair in each clock-pulse period, a potential difference of, for example, 0.3 V existing between inner pump electrode and outer pump electrode in the pump-in phase, and a potential difference of 0.1 V, for instance, existing between outer pump electrode and inner pump electrode in the evacuation phase.

### SUMMARY OF THE INVENTION

The gas sensor according to the exemplary embodiment and/or exemplary method of the present invention has the advantage of a considerably higher measuring accuracy in determining the concentration of the gas components in the measuring gas, in particular in determining the oxygen concentration or the air/fuel ratio (λ) in exhaust gases. The provision of the cavity between diffusion barrier and the inner pump electrode situated on the solid-state electrolyte produces a region having a constant oxygen concentration, which serves as storage volume. In contrast to the gas sensor described in the introduction, the oxygen must therefore not be stored in the diffusion barrier, which shortens the diffusion barrier and falsifies the measuring signal due to the shortened diffusion barrier. Like the known gas sensor described in the introduction, the gas sensor according to the exemplary embodiment and/or exemplary method of the present invention has only two electrodes, which allows a cost-effective production and a wide λ-measuring range, which has been considerably expanded into the enriched range of the exhaust gas. Operating the electrodes with a varying potential improves their pumping ability for oxygen.

Advantageous further refinements and improvements of the gas sensor are rendered possible by the measures specified in the additional claims.

According to one advantageous specific embodiment of the present invention, the pump current, which was measured over one clock-pulse period or a plurality of clock-pulse periods and averaged, is utilized as a measure for the concentration of the gas component, i.e. the λ-value of the exhaust gas. As an alternative, the pump current, measured in the pump-in and evacuation phase and filtered by a time constant that is considerably greater than the cycle duration of the clocking, is used as measure for the concentration of the gas component.

According to one advantageous specific embodiment of the present invention, the oxygen quantity delivered into the cavity in the pump-in phase is controlled as a function of the instantaneous oxygen concentration in the measuring gas. This not only results in the desired broadening of the measuring range in the rich range of an exhaust gas, but also greatly reduces the pumped-in oxygen quantity in the lean range of the exhaust gas so as not to stress the pump electrodes unnecessarily.

To control the fed-in oxygen quantity, the pump current—the so-called bias current—flowing in the pump-in phase may be adjusted as a function of the measured concentration of the gas component. Instead of specifying the bias current, it is also possible to specify a certain charge quantity using which an equivalent oxygen quantity is pumped into the cavity. This is advantageous in those cases where the constancy of the bias current is able to be achieved only with difficulty.

### BRIEF DESCRIPTION OF THE DRAWINGS

FIG. 1 shows in a cutaway, schematized view, a longitudinal section of a sensor element of a gas sensor for measuring the exhaust gas of internal combustion engines.

FIG. 2 shows a diagram to elucidate the functionality of the gas sensor in lean-gas operation.

FIG. 3 shows a diagram to elucidate the functionality of the gas sensor in rich-gas operation.

FIG. 4 shows a block circuit of the gas sensor including sensor element and control device.

FIG. 5 shows a longitudinal section of a sensor element of the gas sensor in various modifications, in a separate cutaway view.

FIG. 6 shows a longitudinal section of a sensor element of the gas sensor in various modifications, in another separate cutaway view.

FIG. 7 shows a longitudinal section of a sensor element of the gas sensor in various modifications, in another separate cutaway view.

FIG. 8 shows a longitudinal section of a sensor element of the gas sensor in various modifications, in another separate cutaway view.

FIG. 9 shows a block diagram of the gas sensor including the sensor element according to FIG. 8 as well as control device.

### DETAILED DESCRIPTION

The gas measuring probe or gas sensor described here is used to determine the concentration of a gas component in a measuring gas, and may be employed as Lambda sensor for determining the oxygen concentration in the exhaust gas of internal combustion engines by which the air/fuel ratio in the exhaust gas of internal combustion engines, which is indicated as so-called λ-value, is ascertained. The following description therefore relates to such a gas sensor for determining the λ value.

The gas-measuring probe or gas sensor has a sensor element 11, shown in FIG. 1 in schematized form in longitudinal section, which is usually accommodated in a housing and exposed to the exhaust gas by its gas-sensitive portion. Situated in the gas-sensitive portion is an electrode pair, which is connected to a connector cable routed out of the housing and to a control device 10 (FIG. 4) with the aid of circuit traces and a connector plug. The electrode pair encompasses an outer pump electrode 12 and an inner pump electrode 13, both of which are situated on a solid-state electrolyte 14, which is made of Yttrium-stabilized zirconium-oxide (ZrO₂), for example. As is not shown further in FIG. 1, solid-state electrolyte 14 is made up of a number of laminated solid-state electrolyte layers or foils, in which an electric resistance heater 15 is disposed, which is embedded in an insulation layer (not shown here). Resistance heater 15 is used to set a constant operating temperature of solid-state electrolyte 14. Outer pump electrode 12 is situated on the outside of solid-state electrolyte 14 and therefore directly exposed to the exhaust gas, whereas the exhaust gas is able to reach inner pump electrode 13 only via a diffusion barrier 16. In the exemplary embodiment of FIG. 1, a cavity 17 is formed inside solid-state electrolyte 14, from which a channel 18 commences, which discharges on the outside of solid-state electrolyte 14. Inner pump electrode 13 is affixed inside cavity 17 on solid-state electrolyte 14, and channel 18 is completely filled with a porous ceramic material such as, for example, ZrO₂ or Al₂O₃ so as to form diffusion barrier 16.

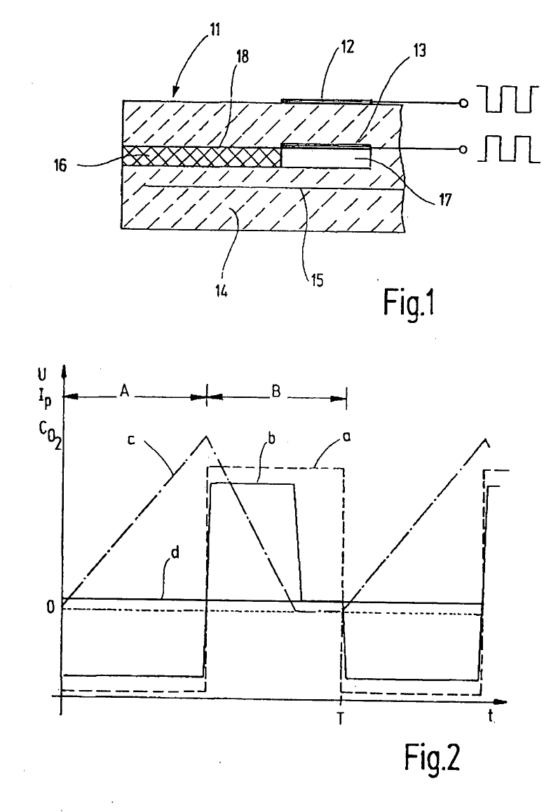

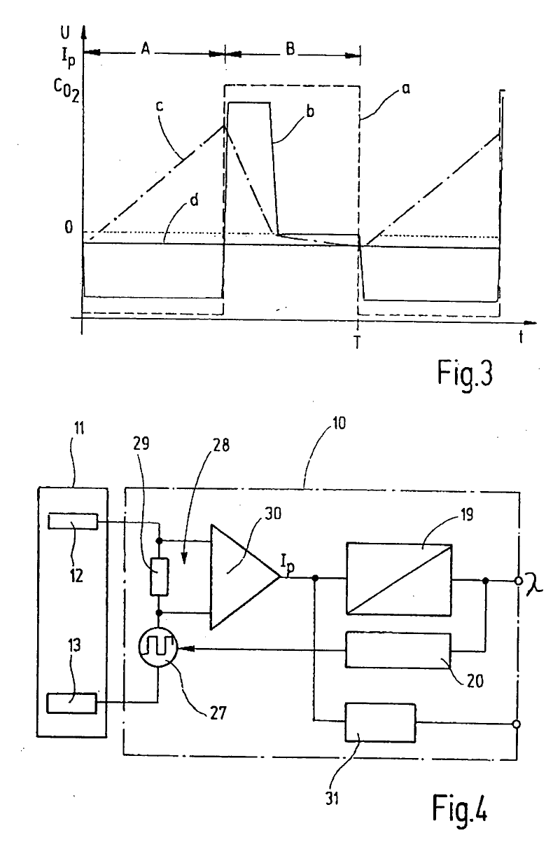

Electrode pair 12, 13 is triggered by a clock-pulse generator 27 of control device 10 (FIG. 4) using a selected clock-pulse frequency and selected pulse-duty factor, a potential of varying polarity being applied to the two pump electrodes 12, 13 in each clock-pulse period T. In the diagrams of FIGS. 2 and 3, the voltage applied to the electrode pair using a 50% pulse-duty factor is illustrated by the dotted line (curve a). In a so-called pump-in phase A, which corresponds to half a clock-pulse period in the example, a positive potential is applied to inner pump electrode 13 (and a negative potential is applied to outer pump electrode 12). This causes negatively charged oxygen ions to diffuse through diffusion barrier 16 to inner pump electrode 13. Due to the oxygen-ion flow, a pump current Iₚ, also referred to as bias current and understood as the movement of positive charge carriers, is flowing from inner pump electrode 13 to outer pump electrode 12 in the pump-in phase. In the following evacuation phase B, which once again extends over half a clock-pulse period in the example, a positive potential is applied at outer pump electrode 12 (and a negative potential at inner pump electrode 13). As a result, negatively charged oxygen ions diffuse through diffusion barrier 16 to the outer pump electrode, and a pump current +Iₚ is flowing from outer electrode 12 to inner electrode 13. It should be noted that both pulse-duty ratio and clock-pulse frequency as well as the applied voltage are variable. The characteristic of pump current Iₚ as movement of positive charge carriers from outer pump electrode 12 to inner pump electrode 13 is shown in FIGS. 2 and 3 in the form of a solid line (curve b). Due to this clocked triggering of electrode pair 12, 13, oxygen is pumped through the solid-state electrolyte into cavity 17 in pump-in phase A, and oxygen is pumped out of cavity 17 via the solid-state electrolyte in evacuation phase B. In addition to the oxygen pumped through the solid-state electrolyte, various exhaust-gas components reach cavity 16, which either discharge oxygen or bind oxygen through an electro-chemical reaction at inner pump electrode 13. The oxygen-equivalent concentration Cₒ₂ produced in cavity 17 overall is shown in FIG. 2 for lean-gas operation, and in FIG. 3 for rich-gas operation as a dot-dash line (curve c) in each case. It should be noted that idealized conditions were assumed in the diagrams in FIGS. 2 and 3 in order to clarify the mechanism taking place. In reality, the transitions in curves b are not quite as abrupt as shown but have a continuous characteristic with a lower gradient.

In lean-gas operation (FIG. 2), oxygen-equivalent concentration Cₒ₂ is generated in cavity 17 in pump-in phase A (rising flank of curve c). In evacuation phase B, oxygen present in cavity 17 is first pumped out (falling flank of curve c). If no further oxygen remains in cavity 17, then pump current Iₚ drops (falling flank of curve b). The lean gas diffusing through diffusion barrier 16 into cavity 17 carries oxygen that is likewise evacuated (horizontal portion of curve b). An average pump current Iₚ comes about (curve d) over the clock-pulse period, which is equivalent to the gas flow flowing through diffusion barrier 16 and provides a measure for the oxygen concentration and thus the air-fuel ratio in the exhaust gas. Pump current Iₚ flowing in every clock-pulse period is measured in a measuring stage 28 made up of a shunt 29 and a differential amplifier 30 of control device 10 (FIG. 4) and averaged over a plurality of clock-pulse periods (block 19 in FIG. 4). As an alternative, pump current Iₚ measured in measuring stage 28 is filtered using a time constant that is considerably greater than cycle duration T of the clocking (block 19 in FIG. 4).

FIG. 3 shows the conditions that were described for lean operation with the aid of FIG. 2, for rich-gas operation. In pump-in phase A, the oxygen pumped into cavity 17 reacts with the rich gas, which either is already present in cavity 17 or which diffuses into cavity 17 via diffusion barrier 16, i.e., with gas component CH₄, which, through bonding of oxygen, lets CO₂ and H₂O come about. The oxygen remaining from the reaction generates an oxygen-equivalent concentration Cₒ₂ in cavity 17 (rising flank of curve c), which is considerably lower than during lean-gas operation. In evacuation phase B, oxygen present in cavity 17 is first pumped out (falling flank of curve c). If no further oxygen remains in cavity 17, then pump current Iₚ returns to zero (falling flank of curve b). Inwardly diffusing rich gas collects in cavity 17, which leads to a need for oxygen (slanted negative portion of curve c). The resulting average value of pump current Iₚ (curve d) once again corresponds to the gas flow through diffusion barrier 16 and constitutes a measure for the λ lambda value that is smaller than 1.

Due to pump current −Iₚ—the so-called bias current—flowing in pump-in phase A, an expansion of the measuring range of the gas sensor in rich-gas operation (fuel excess) is achieved. In lean-gas operation (air excess), this bias current has a disadvantageous effect since it further increases the oxygen quantity forming in cavity 17 by the electrochemical reaction, and thereby further increases the oxygen flow to be pumped, so that electrodes 12, 13 are subjected to unnecessary loading and age faster. As a counter measure, the oxygen quantity pumped into cavity 17 in pump-in phase A is adjusted as a function of the oxygen concentration in the exhaust gas, i.e., the air/fuel ratio. This may be achieved by varying the pulse-duty factor or by variable dimensioning of bias current −Iₚ, so that, in lean-gas operation, bias current −Iₚ becomes sufficiently small to relieve the stress on electrodes 12, 13. The lambda signal able to be picked up at block 19 in control device 10 and fed into a filter 20, such as a PID filter, is used to set the bias current. The output of filter 20 determines the magnitude of the bias current.

As an alternative, it is not a specific constant bias current that is defined in control device 10 as a function of the lambda signal, but a specific charge quantity, which is pumped into cavity 17 as equivalent oxygen quantity. This is advantageous in those cases where the constancy of the bias current is able to be achieved only with difficulty.

For the continuous measurement of the inner resistance of sensor element 11, a sample and hold circuit 31 is connected to the output of differential amplifier 30 in control device 10, which samples bias current −Iₚ once every clock-pulse period and holds the sampling value until the next measurement. Using the measured resistance value, the temperature of the solid-state electrolyte is able to be constantly controlled to the operating temperature with the aid of resistance heater 15 provided in sensor element 11.

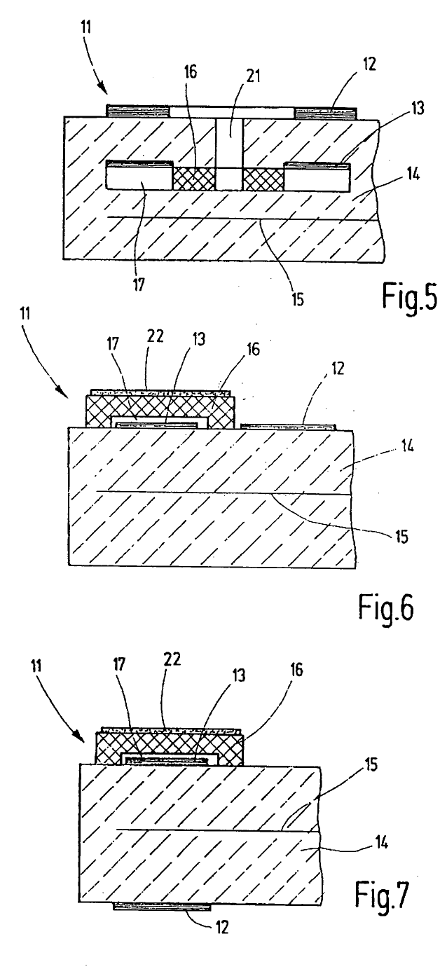

FIGS. 5, 6 and 7 show three sensor elements 11 in longitudinal, part-sectional view, these sensor elements being modified with regard to the placement of pump electrodes 12, 13, cavity 17 and diffusion barrier 16. In the sensor element according to FIG. 5, cavity 17 and diffusion barrier 16 are designed as concentric rings, and diffusion barrier 16 encloses a gas-entry channel 21 discharging on the outside of solid-state electrolyte 14, and cavity 17 encloses diffusion barrier 16. The two pump electrodes 12, 13 are embodied as ring electrodes, which are separated by the solid-state electrolyte, outer pump electrode 12 once again being affixed on the outside of solid-state electrolyte 14 so as to concentrically enclose gas-entry channel 21, and inner pump electrode 13 being disposed inside cavity 17 and likewise being affixed on solid-state electrolyte 14.

In the exemplary embodiment of FIG. 6, outer pump electrode 12 and inner pump electrode 13 are situated on the outside of solid-state electrolyte 14, i.e., on the same large surface. Forming cavity 17, inner pump electrode 13 is covered by diffusion barrier 16, which has a box-like design for this purpose and is resting on the outer side of solid-state electrolyte 14 via its box edges. Diffusion barrier 16 may also be covered by a protective layer 22.

Sensor element 11 according to FIG. 7 differs from sensor element 11 in FIG. 6 only in that outer pump electrode 12 is situated on the other large surface of solid-state electrolyte 14, which faces away from the large surface that supports inner pump electrode 13 having diffusion barrier 16.

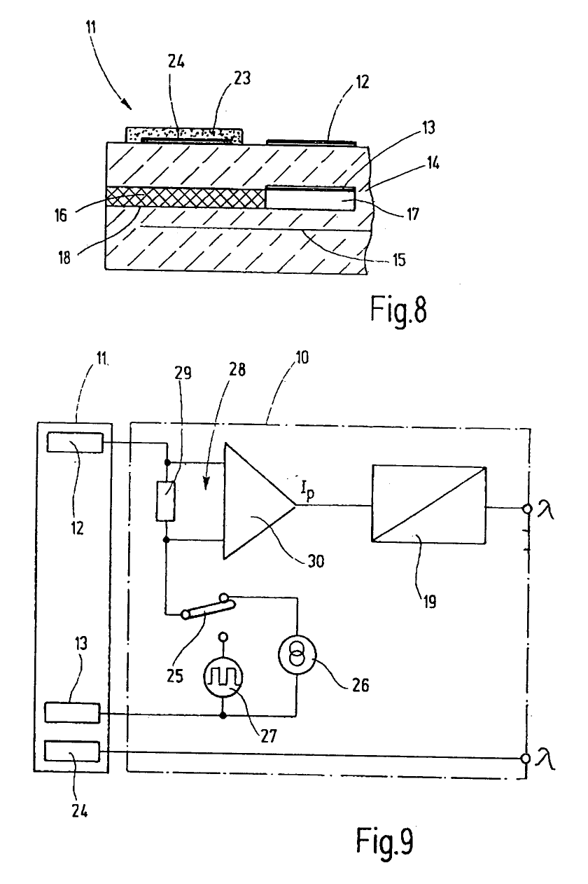

FIG. 8 shows a sensor element 11, whose design is identical design to that of FIG. 1, but which has an additional electrode on the outside of solid-state electrolyte 14, which forms a so-called Nernst electrode 24 and is covered by a porous protective layer 23. Using this additional outer electrode, a voltage-jump or λ=1 sensor may additionally be realized by sensor element 11. Inner pump electrode 13 disposed within cavity 17 is used as reference electrode, which may readily be realized by suppressing evacuation phase B, so that cavity 17 remains filled with oxygen at all times. As illustrated in the block diagram of FIG. 9, the sensor element is switched in the control device from the “broadband sensor” operating mode to the “voltage jump sensor” operating mode for this purpose, which is symbolically indicated by throwing switch 25 in FIG. 9. This causes clock-pulse generator 27 to be switched off in control device 10, and a reference current source 26 to be applied to electrode pair 12, 13. The λ value, which is tapped at lower λ output of control device 10 in FIG. 9, is derived from the potential of Nernst electrode 24. After switch 25 has been moved back into the lower switch position in FIG. 9, the “broadband sensor” operating mode has been reset, and the λ value is available at upper λ output of control device 10 in FIG. 9.

In the measuring probe described in different variants of an embodiment, it is also possible to expose outer pump electrode 12, which is situated on the outside of solid-state electrolyte 14 and exposed to the measuring or exhaust gas, to a reference gas, which may be atmospheric air, without this causing a change in the function of the measuring sensor.

The measuring sensor may also be used to determine the concentration of nitrogen oxides in the exhaust gas of internal combustion engines.

In the exemplary embodiment described, the pump voltage applied to electrode pair 12, 13 is predefined in control device 10 (FIG. 4). Instead of the pump voltage, it is also possible to specify the pump current.

1-12. (canceled)

13. A gas sensor for determining a concentration of a gas component in a measuring gas, comprising:
an outer pump electrode; and
an inner pump electrode, wherein the outer pump electrode and the inner pump electrode form an electrode pair disposed on a solid-state electrolyte, accessible to the measuring gas supplied via a diffusion barrier, the electrode pair being triggered in a clocked manner and having a potential of varying polarity applied in each clock-pulse period, so that, in a pump-in phase, a pump current flows from the inner pump electrode to the outer pump electrode, and in an evacuation phase, an inverse pump current flows from the outer electrode to the inner electrode, wherein a cavity is situated between the diffusion barrier and the inner pump electrode.

14. The gas sensor of claim 13, wherein the outer pump electrode is exposed to the measuring gas.

15. The gas sensor of claim 13, wherein the outer pump electrode is exposed to a reference gas of atmospheric air.

16. The gas sensor of claim 13, wherein the cavity is formed in a solid-state electrolyte, which is made up of solid-state electrolyte layers, and a measuring-gas access channel discharges into the cavity, and the outer pump electrode is situated on an outside of the solid-state electrolyte, and the inner pump electrode is situated within the cavity.

17. The gas sensor of claim 13, wherein:
the cavity and the diffusion barrier are embodied as rings concentrically disposed inside the solid-state electrolyte,
the diffusion barrier encloses a measuring-gas access channel discharging on an outside of the solid-state electrolyte,
the outer electrode has an annular design and is situated on the outside of the solid-state electrolyte concentrically to the channel outlet, and
the inner pump electrode has an annular design and is accommodated within the cavity.

18. The gas sensor of claim 13, wherein the outer pump electrode and the inner pump electrode are disposed on an identical outer surface or on outer surfaces of the solid-state electrolyte facing away from one another, and wherein the inner pump electrode is covered by the diffusion barrier while forming the cavity.

19. The gas sensor of claim 13, wherein the pump current measured over at least one clock-pulse period and averaged constitutes the measure for the concentration of the gas component in the measuring gas.

20. The gas sensor of claim 13, wherein the pump current, measured and filtered by a time constant that is considerably greater than the cycle period of the clocking, constitutes the measure for the concentration of the gas component in the measuring gas.

21. The gas sensor of claim 13, wherein the pump current flowing from the inner pump electrode to the outer pump electrode in the pump-in phase, or a charge quantity transported in the pump-in phase, is regulated as a function of the concentration of the gas component in the measuring gas.

22. The gas sensor of claim 21, wherein the measured, averaged or filtered pump current is conveyed to a PID filter, at whose output the controlled variable is available.

23. The gas sensor of claim 16, wherein a Nernst electrode, which is covered by a porous cover layer, is situated on an outer surface of the solid-state electrolyte, which is particularly on the outer surface supporting the outer electrode, and wherein the inner pump electrode is acted upon by a reference gas, and the potential of the Nernst electrode forms the measure for the concentration of the gas component in the measuring gas.

24. The gas sensor of claim 23, wherein the evacuation phase is suppressible for applying a reference gas to the inner pump electrode, and the inner pump electrode is supplied with a reference pump current.

25. The gas sensor of claim 13, wherein an oxygen concentration in an exhaust gas of an internal combustion engine is determined.
